(19) United States
(12) Patent Application Publication
(10) Pub. No.: US 2026/0329730 A1
(43) Pub. Date: Oct. 22, 2026

(54) PR-TEST RECOMMENDATION SYSTEM BASED ON FP-GROWTH ALGORITHM AND GIT HISTORY

(71) Applicant: Dell Products L.P., Round Rock, TX (US)

(72) Inventors: Lei Lei, Shanghai (CN); Chen Zhang, Shanghai (CN); Xing Chen, Shanghai (CN); Dazhi Dong, Shanghai (CN); David Sydow, Merrimack, NH (US); Amber Jing Li, Chengdu (CN)

(73) Assignee: Dell Products L.P., Round Rock, TX (US)

(21) Appl. No.: 19/180,774

(22) Filed: Apr. 16, 2025

(51) Int. Cl. G06F 11/3668

(52) U.S. Cl. CPC G06F 11/3684; G06F 11/368; G06F 11/3688

(57) ABSTRACT

Methods, system, and non-transitory processor-readable storage medium for a pull request test recommendation system are provided herein. An example method includes receiving, by a pull request test recommendation system, a software pull request with changed files. The pull request test recommendation system creates a frequent pattern tree based on a minimum transaction set, where the minimum transaction set comprises the changed files. The pull request test recommendation system applies a frequent pattern growth algorithm to find frequent item sets based on the frequent pattern tree. The pull request test recommendation system generates a recommended test list for the software pull request by identifying rules whose file sets are contained within the changed file set of the software pull request.

### FIELD

The field relates generally to software pull requests, within information processing systems.

### BACKGROUND

In the software development process of large software products, many pull requests (PR) are submitted frequently.

### SUMMARY

Illustrative embodiments provide techniques for implementing a pull request test recommendation system in a storage system. For example, illustrative embodiments comprise a pull request test recommendation system receiving a software pull request with changed files. The pull request test recommendation system creates a frequent pattern tree based on a minimum transaction set, where the minimum transaction set comprises the changed files. The pull request test recommendation system applies a Frequent Pattern Growth algorithm to find frequent item sets based on the frequent pattern tree. The pull request test recommendation system generates a recommended test list for the software pull request by identifying rules whose file sets are contained within the changed file set of the software pull request. Other types of processing devices can be used in other embodiments. These and other illustrative embodiments include, without limitation, apparatus, systems, methods and processor-readable storage media.

### BRIEF DESCRIPTION OF THE DRAWINGS

FIG. 1 illustrates an information processing system including a pull request test recommendation system, in an illustrative embodiment.

FIG. 2 illustrates a flow diagram of a process for a pull request test recommendation system, in an illustrative embodiment.

FIG. 3 illustrates a system architecture for a pull request test recommendation system, in an illustrative embodiment.

FIGS. 4 and 5 show examples of processing platforms that may be utilized to implement at least a portion of a pull request test recommendation system embodiments.

### DETAILED DESCRIPTION

Illustrative embodiments will be described herein with reference to exemplary computer networks and associated computers, servers, network devices or other types of processing devices. It is to be appreciated, however, that these and other embodiments are not restricted to use with the particular illustrative network and device configurations shown. Accordingly, the term “computer network” as used herein is intended to be broadly construed, so as to encompass, for example, any system comprising multiple networked processing devices.

Described below is a technique for use in implementing a pull request test recommendation system, which technique may be used to generate a recommended test list for a newly received software pull request. The pull request test recommendation system receives a software pull request with changed files. The pull request test recommendation system creates a frequent pattern tree based on a minimum transaction set, where the minimum transaction set comprises the changed files. The pull request test recommendation system applies a Frequent Pattern Growth algorithm to find frequent item sets based on the frequent pattern tree. The pull request test recommendation system generates a recommended test list for the software pull request by identifying rules whose file sets are contained within the changed file set of the software pull request.

In the software development process of a large software product, there typically are dozens of pull requests submitted each day. As a mature software development management process, many tests are defined for ensuring code quality. The number of these tests can reach hundreds and the execution time of all the tests are extraordinarily long. It is often not possible and not necessary to run all the tests for each new pull request. Therefore, a subset of the tests, those related to the code change in the pull request, should be executed.

Conventional technologies rely on manual processes to select the subset of tests necessary to test the changed files in the pull request, requiring human resources, and resulting in possible human error. Conventional technologies fail to provide a self-learning system that recommends tests based on data mining git commit history and test history. Conventional technologies fail to provide a system that automatically recommends tests within seconds once a new pull request is submitted.

By contrast, in at least some implementations in accordance with the current technique as described herein, an improvement in selecting test cases for testing a newly received pull request is achieved by a pull request test recommendation system that receives a software pull request with changed files. The pull request test recommendation system creates a frequent pattern tree based on a minimum transaction set, where the minimum transaction set comprises the changed files. The pull request test recommendation system applies a Frequent Pattern Growth algorithm to find frequent item sets based on the frequent pattern tree. The pull request test recommendation system generates a recommended test list for the software pull request by identifying rules whose file sets are contained within the changed file set of the software pull request.

Thus, a goal of the current technique is to provide a method and a system that automatically recommends the necessary tests for a new pull request based on the new pull request's changed files. Another goal is to provide a pull request test recommendation system that uses a FP-Growth algorithm and leverages pull request code change history and the pull request test history. Yet another goal is to provide a self-learning system that recommends tests based on data mining git commit history and test history.

In at least some implementations in accordance with the current technique described herein, the use of a pull request test recommendation system can provide one or more of the following advantages: automatically recommends the necessary tests for a new pull request based on the new pull request's changed files, and provides a confidence percentage level along with the recommended tests, allowing a reviewer to easily see why the identified tests are recommended.

In contrast to conventional technologies, in at least some implementations in accordance with the current technique as described herein, an improvement in selecting test cases to perform testing on a newly received pull request is achieved by a pull request test recommendation system that receives a software pull request with changed files. The pull request test recommendation system creates a frequent pattern tree based on a minimum transaction set, where the minimum transaction set comprises the changed files. The pull request test recommendation system applies a Frequent Pattern Growth algorithm to find frequent item sets based on the frequent pattern tree. The pull request test recommendation system generates a recommended test list for the software pull request by identifying rules whose file sets are contained within the changed file set of the software pull request.

In an example embodiment of the current technique, the pull request test recommendation system collects historical pull request data including changed file sets and test sets from at least one repository to generate a hash map.

In an example embodiment of the current technique, the repository comprises git history and test history.

In an example embodiment of the current technique, the hash map comprises pull request IDs as keys and corresponding sets of changed files and test names as values.

In an example embodiment of the current technique, the hash map is a hash map database that is updated periodically with additional historical pull request data.

In an example embodiment of the current technique, the test history comprises a GitHub Enterprise server.

In an example embodiment of the current technique, the pull request test recommendation system checks each file in the software pull request's changed file set against transactions collected from git history and selects matching transactions that contain at least one file from the changed file set to include in the minimum transaction set.

In an example embodiment of the current technique, the pull request test recommendation system defines a minimum support threshold value that determines which transactions are chosen to build the frequent pattern tree.

In an example embodiment of the current technique, the pull request test recommendation system generates rules based on the frequent item sets, where each rule comprises a file set and an associated test, and has a confidence value meeting or exceeding a minimum confidence threshold.

In an example embodiment of the current technique, the pull request test recommendation system calculates support values for each frequent item set, splits each frequent item set into a file set and a test set and determines confidence values between file sets and individual tests.

In an example embodiment of the current technique, the pull request test recommendation system counts occurrences of the frequent item set in all transactions.

In an example embodiment of the current technique, the pull request test recommendation system generates the rules using frequent item sets comprised of one non-empty file set and one single test.

In an example embodiment of the current technique, the pull request test recommendation system filters out any frequent item sets containing multiple tests from consideration when generating the rules.

In an example embodiment of the current technique, a confidence value represents a probability that when the file set exists in a transaction, a test also exists in the transaction.

In an example embodiment of the current technique, the pull request test recommendation system defines a minimum confidence threshold value that determines which tests are recommended.

In an example embodiment of the current technique, the pull request test recommendation system provides identified patterns with the recommended test list to clarify selection of the recommended test list.

In an example embodiment of the current technique, the pull request test recommendation system recommends tests associated with matching rules.

In an example embodiment of the current technique, a test automation system receives the software pull request and executes the tests associated with the recommended test list.

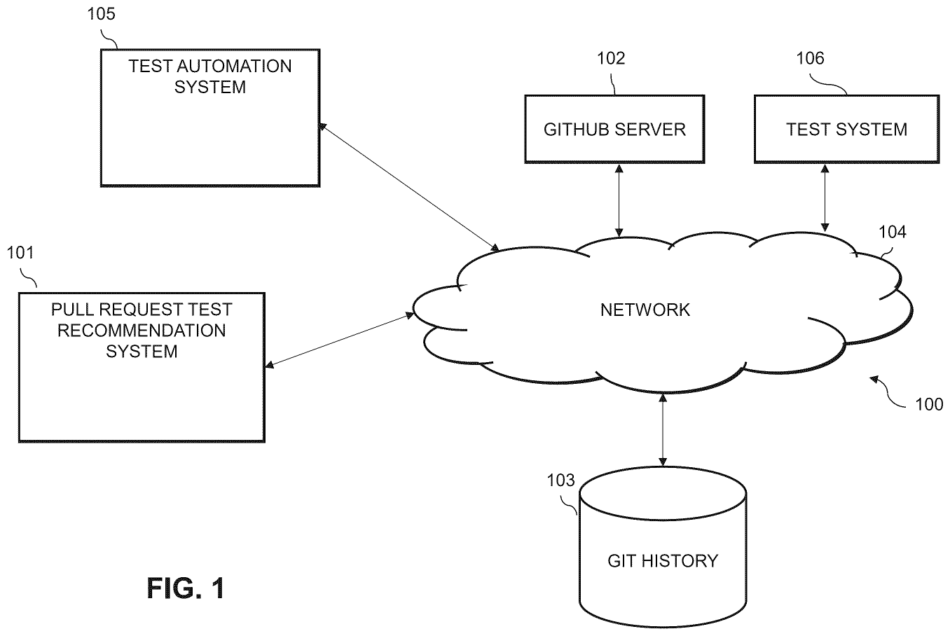

FIG. 1 shows a computer network (also referred to herein as an information processing system) 100 configured in accordance with an illustrative embodiment. The computer network 100 comprises a pull request test recommendation system 101, a test automation system 105, a git history 103, github server 102, and test system 106. The pull request test recommendation system 101, test automation system 105, git history 103, github server 102, and test system 106 are coupled to a network 104, where the network 104 in this embodiment is assumed to represent a sub-network or other related portion of the larger computer network 100. Accordingly, elements 100 and 104 are both referred to herein as examples of “networks,” but the latter is assumed to be a component of the former in the context of the FIG. 1 embodiment. The pull request test recommendation system 101 may reside on a storage system. Such storage systems can comprise any of a variety of different types of storage including network-attached storage (NAS), storage area networks (SANs), direct-attached storage (DAS) and distributed DAS, as well as combinations of these and other storage types, including software-defined storage.

Each of the pull request test recommendation system 101, test automation system 105, github server 102, and test system 106 may comprise, for example, servers and/or portions of one or more server systems, as well as devices such as mobile telephones, laptop computers, tablet computers, desktop computers or other types of computing devices. Such devices are examples of what are more generally referred to herein as “processing devices.” Some of these processing devices are also generally referred to herein as “computers.”

The pull request test recommendation system 101, test automation system 105, github server 102, and test system 106 in some embodiments comprise respective computers associated with a particular company, organization or other enterprise. In addition, at least portions of the computer network 100 may also be referred to herein as collectively comprising an “enterprise network.” Numerous other operating scenarios involving a wide variety of different types and arrangements of processing devices and networks are possible, as will be appreciated by those skilled in the art.

Also, it is to be appreciated that the term “user” in this context and elsewhere herein is intended to be broadly construed so as to encompass, for example, human, hardware, software or firmware entities, as well as various combinations of such entities.

The network 104 is assumed to comprise a portion of a global computer network such as the Internet, although other types of networks can be part of the computer network 100, including a wide area network (WAN), a local area network (LAN), a satellite network, a telephone or cable network, a cellular network, a wireless network such as a Wi-Fi or WiMAX network, or various portions or combinations of these and other types of networks. The computer network 100 in some embodiments therefore comprises combinations of multiple different types of networks, each comprising processing devices configured to communicate using internet protocol (IP) or other related communication protocols.

Also associated with the pull request test recommendation system 101 are one or more input-output devices, which illustratively comprise keyboards, displays or other types of input-output devices in any combination. Such input-output devices can be used, for example, to support one or more user interfaces to the pull request test recommendation system 101, as well as to support communication between the pull request test recommendation system 101 and other related systems and devices not explicitly shown. For example, a dashboard may be provided for a user to view results produced by the pull request test recommendation system 101. One or more input-output devices may also be associated with any of the test automation system 105, git history 103, github server 102, and test system 106.

Additionally, the pull request test recommendation system 101 in the FIG. 1 embodiment is assumed to be implemented using at least one processing device. Each such processing device generally comprises at least one processor and an associated memory, and implements one or more functional modules for controlling certain features of the pull request test recommendation system 101.

More particularly, the pull request test recommendation system 101 in this embodiment can comprise a processor coupled to a memory and a network interface. The processor illustratively comprises a microprocessor, a microcontroller, an application-specific integrated circuit (ASIC), a field-programmable gate array (FPGA) or other type of processing circuitry, as well as portions or combinations of such circuitry elements.

The memory illustratively comprises random access memory (RAM), read-only memory (ROM) or other types of memory, in any combination. The memory and other memories disclosed herein may be viewed as examples of what are more generally referred to as “processor-readable storage media” storing executable computer program code or other types of software programs.

One or more embodiments include articles of manufacture, such as computer-readable storage media. Examples of an article of manufacture include, without limitation, a storage device such as a storage disk, a storage array or an integrated circuit containing memory, as well as a wide variety of other types of computer program products. The term “article of manufacture” as used herein should be understood to exclude transitory, propagating signals. These and other references to “disks” herein are intended to refer generally to storage devices, including solid-state drives (SSDs), and should therefore not be viewed as limited in any way to spinning magnetic media.

The network interface allows the pull request test recommendation system 101 to communicate over the network 104 with the test automation system 105, git history 103, github server 102, and test system 106 and illustratively comprises one or more conventional transceivers.

A pull request test recommendation system 101 may be implemented at least in part in the form of software that is stored in memory and executed by a processor, and may reside in any processing device. The pull request test recommendation system 101 may be a standalone plugin that may be included within a processing device.

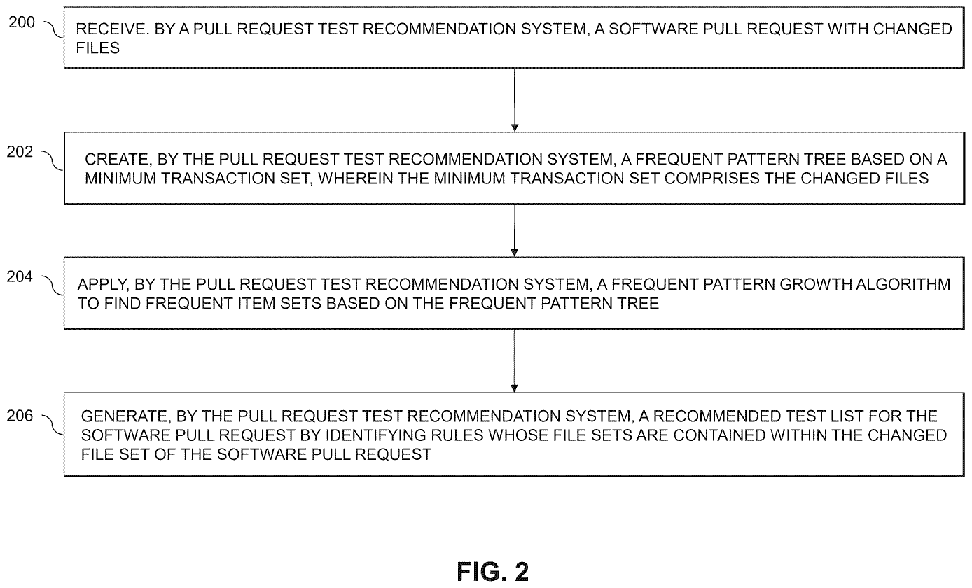

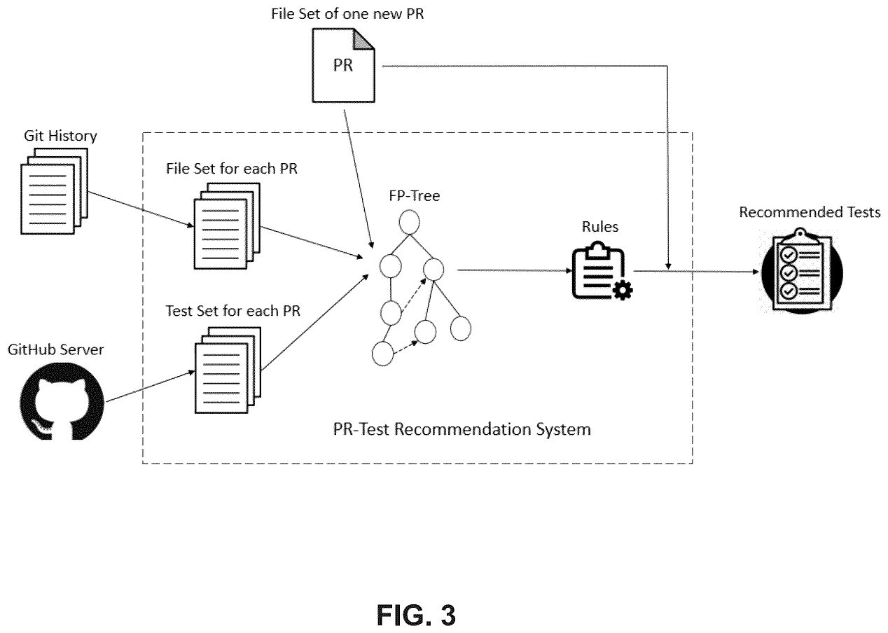

It is to be understood that the particular set of elements shown in FIG. 1 for pull request test recommendation system 101 involving the pull request test recommendation system 101, test automation system 105, git history 103, github server 102, and test system 106 of computer network 100 is presented by way of illustrative example only, and in other embodiments additional or alternative elements may be used. Thus, another embodiment includes additional or alternative systems, devices and other network entities, as well as different arrangements of modules and other components. For example, in at least one embodiment, one or more of the pull request test recommendation system 101 can be on and/or part of the same processing platform. An exemplary process of pull request test recommendation system 101 in computer network 100 will be described in more detail with reference to, for example, the flow diagram of FIG. 2.

FIG. 2 is a flow diagram of a process for execution of the pull request test recommendation system 101 in an illustrative embodiment. It is to be understood that this particular process is only an example, and additional or alternative processes can be carried out in other embodiments.

At 200, the pull request test recommendation system 101 receives a software pull request (i.e., a new software pull request) with changed files. In an example embodiment, the pull request test recommendation system 101 receives a new software pull request with a changed file set, for example, file A, file B, and file C.

In an example embodiment, the pull request test recommendation system 101 collects historical pull request data including changed file sets and test sets from at least one repository to generate a hash map. In an example embodiment, the repository comprises git history 103 and test history, from a github server 102. In an example embodiment, the pull request test recommendation system 101 collects each historical pull request's changed file set from git history 103. In an example embodiment, the pull request test recommendation system 101 collects each historical pull request's test set from a GitHub enterprise server, such as github server 102. In an example embodiment, the pull request test recommendation system 101 collects each historical pull request's test history using Git Representational State Transfer Application Program Interfaces (REST APIs).

In an example embodiment, the pull request test recommendation system 101 collects historical pull request data including changed file sets and test sets from git history 103 and test history (i.e., GitHub server 102), such as the GitHub Enterprise server, each time the pull request test recommendation system 101 updates the hash map with additional historical pull request data. In an example embodiment, the hash map is a hash map database that is updated periodically with additional historical pull request data.

In an example embodiment, the hash map comprises pull request IDs as keys and corresponding sets of changed files and test names as values. An example hash map is listed below:

```
{
    ″Pull Request 1″: [
      “a.java″, “b.java″, “c.java”,
      “test_1”, “test_2”
  ],
    ″Pull Request 2″: [
      “c.java″, “d.java″,
      “test_2”, “test_3”
  ],
    ″Pull Request 3″: [
      “b.java″, “c.java″, “d.java“,
      “test_2”, “test_3”, “test_4”
  ],
  ...
}
```

At 202 the pull request test recommendation system 101 creates a frequent pattern tree based on a minimum transaction set, where the minimum transaction set comprises the changed files. In an example embodiment, the pull request test recommendation system 101 checks each file in the software pull request's changed file set against transactions collected from git history 103, and selects matching transactions that contain at least one file from the changed file set to include in the minimum transaction set.

In an example embodiment, the pull request test recommendation system 101 defines a minimum support threshold value that determines which transactions are chosen to build the frequent pattern tree. In an example embodiment, the pull request test recommendation system 101 creates a “transaction” that is a list composed of changed files and test names for a specific software pull request. For example, using the example hash map above, the transaction is [a.java, b.java, c.java, test_1, test_2].

In an example embodiment, the pull request test recommendation system 101 determines the support for the software pull request. The support is how many transactions in the whole git history 103 contain one specific changed file or test name. For example, Support (“a.java”)=1, Support (“c.java”)=3.

In an example embodiment, the pull request test recommendation system 101 determines the minimum value of support, min_support, which is the threshold for choosing transactions to build a frequent pattern tree. For example, min_support=3.

In an example embodiment, the pull request test recommendation system 101 determines a frequent item set, which is one set of files and/or tests that must satisfy a condition. For example, Support (FS)≥min_support, where FS is a frequent item set. In this example, if min_support=2, then [“c.java”] is a frequent item set, [“c.java”, “d.java”] is also a frequent item set, and [“test_2”, “test_3”] is also a frequent item set, etc. In an example embodiment, any sub-set of one frequent item set is still a frequent item set, and any super-set of a non-frequent item set is still a non-frequent item set.

In an example embodiment, the pull request test recommendation system 101 determines a confidence value for a file set S and a test T as follows:

$$confidence ( S , T ) = \frac{support ( S ⋃ \{ T \} )}{support ( S )}$$

The confidence value indicates the probability of the test T existing when the file set S exists in one transaction. For example, if Support ([“c.java”])=3, Support ([“c.java”, “test_3”])=2, then Confidence ([“c.java”], “[test_3”])=2/3=66.67%. In other words, when c.java appears in one transaction, the probability of test_3 also appearing in the same transaction is 66.67%.

In an example embodiment, the pull request test recommendation system 101 determines a min_confidence value, indicating a minimum threshold to recommend tests. For example, a min_confidence value can be set at 80%.

In an example embodiment, the pull request test recommendation system 101 determines a rule that S=>T, where S is a file set and T is a test set. Thus, confidence (S, T)≥min_confidence. For example, [“c.java”, “d.java”]=>[“test_2”].

At 204, the pull request test recommendation system 101 applies a Frequent Pattern Growth algorithm (FP-Growth algorithm) to find frequent item sets based on the frequent pattern tree. A frequent pattern tree is a data structure for the FP-Growth algorithm. The pull request test recommendation system 101 utilizes the FP-Growth algorithm to determine the frequent item sets per the given transactions. The frequent item sets are used to generate rules and the rules are used to recommend test for the software pull request. In an example embodiment, the pull request test recommendation system 101 collects all the transactions from the git history 103 into one list, identified as L. All the transactions are the values of the hash map, identified as H, that was generated by the pull request test recommendation system 101. In an example embodiment, the new software pull request comprises a changed file set identified as S_{new}. For each file in S_{new}, the pull request test recommendation system 101 checks each transaction in the transaction list L. For example:
L=[[“a.java”, “b.java”, “c.java”, “test_1”, “test_2”],
   [“c.java”, “d.java”, “test_2”, “test_3”],
   [“b.java”, “c.java”, “d.java”, “test_2”, “test_3”, “test_4”]
   [“d.java”, “e.java”, “f.java”, “test_3”, “test_5”],
   [“k.java”, “p.java”, “q.java”, “test_3”, “test_6”, “test_7”]]

If the transaction contains that file, the pull request test recommendation system 101 places the transaction into a transaction set, indicated as TS. For example, S_{new}=[“c.java”, “d.java”, “x.java”, “y.java”], and
TS=[[“a.java”, “b.java”, “c.java”, “test_1”, “test_2”],
   [“c.java”, “d.java”, “test_2”, “test_3”],
   [“b.java”, “c.java”, “d.java”, “test_2”, “test_3”, “test_4”]
   [“d.java”, “e.java”, “f.java”, “test_3”, “test_5”]].

In an example embodiment, the pull request test recommendation system 101 creates the frequent pattern tree based on the transaction set TS. The TS is the minimum transaction set that contains all the relative and necessary transactions according to the new software pull request's changed files.

In an example embodiment, the pull request test recommendation system 101 leverages the FP-Growth algorithm to find the frequent item sets based on the frequent pattern tree.

In an example embodiment, if the min_support=2, a subset of the frequent item sets are as follows:
[“b.java”], support=2
[“c.java”], support=3
[“d.java”], support=3
[“test_2”], support=3
[“test_3”], support=3
[“b.java”, “c.java”], support=2
[“c.java”, “d.java”], support=2
[“b.java”, “test_2”], support=2
[“c.java”, “test_2”], support=3
[“c.java”, “test_3”], support=2
[“d.java”, “test_2”], support=2
[“d.java”, “test_3”], support=3
[“test_2”, “test_3”], support=2
[“b.java”, “c.java”, “test_2”], support=2
[“c.java”, “d.java”, “test_2”], support=2
[“c.java”, “d.java”, “test_3”], support=2

In an example embodiment, for each frequent item set, the pull request test recommendation system 101 calculates a respective Support value. In other words, the pull request test recommendation system 101 counts the occurring number of each frequent item set in all the transactions.

At 206, the pull request test recommendation system 101 generates a recommended test list for the software pull request by identifying rules whose file sets are contained within the changed file set of the software pull request. In an example embodiment, the pull request test recommendation system 101 generates rules based on the frequent item sets, where each rule comprises a file set and an associated test, and has a confidence value meeting or exceeding a minimum confidence threshold. In an example embodiment, the pull request test recommendation system 101 calculates support values for each frequent item set by counting occurrences of the frequent item set in all transactions.

In an example embodiment, for each frequent item set, the pull request test recommendation system 101 splits each frequent item set into a file set S and a test set T. In an example embodiment, the pull request test recommendation system 101 generates the rules using frequent item sets comprised of one non-empty file set and one single test. In an example embodiment, the pull request test recommendation system 101 filters out any frequent item sets containing multiple tests from consideration when generating the rules. In an example embodiment, if the file set S or the test set T is empty, the pull request test recommendation system 101 does not generate any rules. If the test set T's size is greater than 1, then the pull request test recommendation system 101 ignores the test set S because one frequent item set's sub-set must be one frequent item set as noted above. In other words, if a test set T's size is greater than 1, then any single test of this test set T plus the file set S must also be one frequent item set. The pull request test recommendation system 101 determines there is no need to perform duplicated calculations on the test sets T which have more than one test. In an example embodiment, the pull request test recommendation system 101 then determines confidence values between file sets and individual tests. Thus, the pull request test recommendation system 101 focuses on only the frequent item set composed of one non-empty file set S and one single test T, and checks if a particular condition is satisfied. If the condition is satisfied, the pull request test recommendation system 101 generates the rule S=>T.

In an example embodiment, the confidence value represents a probability that when the file set exists in a transaction, a test also exists in the transaction. For example:
Confidence ([“d.java”], [“test_2”])=
Support ([“d.java”, “test_2”])/Support (“[d.java]”)=2/3=66.67%
Confidence ([“c.java”, “d.java”], [“test_3”])=
Support ([“c.java”, “d.java”, “test_3”])/Support ([“c.java”, “d.java”])=2/2=100%

In an example embodiment, if the min_confidence is 60%, then above two are rules, for example:
Rule-1: [“d.java”]=>[“test_2”], confidence=66.67%
Rule-2: [“c.java”, “d.java”]=>[“test_3”], confidence=100%

In an example embodiment, the pull request test recommendation system 101 generates a rule list RL and generates the recommended tests that match the rule list RL. In an example embodiment, the pull request test recommendation system 101 defines a minimum confidence threshold value that determines which tests are recommended. In an example embodiment, the pull request test recommendation system 101 recommends tests associated with matching rules. In an example embodiment, the pull request test recommendation system 101 provides identified patterns with the recommended test list to clarify selection of the recommended test list. For each rule r in the rule list RL, the pull request test recommendation system 101 checks if the software pull request's file set S_{new} contains the file set S of rule r. If yes, the software pull request's file set hits rule r, and therefore, the pull request test recommendation system 101 recommends the test set T of rule r.

For example, the new software pull request contains the four files [c.java, d.java, x.java, y.java].

Using these files, and applying the following rules below, the recommended tests list is [“test_2”, “test_3”].
Rule-1: [“d.java”]=>[“test_2”], confidence=66.67%
Rule-2: [“c.java”, “d.java”]=>[“test_3”], confidence=100%

In an example embodiment, the pull request test recommendation system 101 loops through all the rules in the rule list RL to generate the final recommended test list for the software pull request. Essentially, the pull request test recommendation system 101 is comprised of two phases, phase 1 and phase 2. Phase 1 generates one big hash map H comprising the set of changed files and test names. The input of phase 2 is the set of changed files and the output of phase 2 is the list of recommended tests.

In an example embodiment, a test automation system 105 receives the software pull request. The pull request test recommendation system 101 automatically generates the recommended test list within seconds. The test automation system 105 then executes the tests, for example, on a test system 106, associated with the recommended test list to test the changed files in the software pull request. Thus, the test automation system 105 executes a subset of the available tests (i.e., the tests associated with the recommended test list), where the subset of tests targets testing the changed files in the software pull request, thereby optimizing the testing of the software pull request while reducing the test time of executing all the available tests. The recommended test list allows the test automation system 105 to avoid the unnecessary step of executing tests that do not exercise the changed files in the software pull request.

The above-described illustrative embodiments provide significant advantages relative to conventional approaches. For example, some embodiments are configured to automatically recommends tests within seconds of the submission of a new pull request. These and other embodiments can effectively improve selection of tests to execute to test the changed files in a pull request. Embodiments disclosed herein automatically recommend the necessary tests for a new pull request based on the new pull request's changed files. Embodiments disclosed herein provide a confidence percentage level along with the recommended tests, allowing a reviewer to easily see why the identified tests are recommended.

It is to be appreciated that the particular advantages described above and elsewhere herein are associated with particular illustrative embodiments and need not be present in other embodiments. Also, the particular types of information processing system features and functionality as illustrated in the drawings and described above are exemplary only, and numerous other arrangements may be used in other embodiments.

As mentioned previously, at least portions of the information processing system 100 can be implemented using one or more processing platforms. A given such processing platform comprises at least one processing device comprising a processor coupled to a memory. The processor and memory in some embodiments comprise respective processor and memory elements of a virtual machine or container provided using one or more underlying physical machines. The term “processing device” as used herein is intended to be broadly construed so as to encompass a wide variety of different arrangements of physical processors, memories and other device components as well as virtual instances of such components. For example, a “processing device” in some embodiments can comprise or be executed across one or more virtual processors. Processing devices can therefore be physical or virtual and can be executed across one or more physical or virtual processors. It should also be noted that a given virtual device can be mapped to a portion of a physical one.

Some illustrative embodiments of a processing platform used to implement at least a portion of an information processing system comprises cloud infrastructure including virtual machines implemented using a hypervisor that runs on physical infrastructure. The cloud infrastructure further comprises sets of applications running on respective ones of the virtual machines under the control of the hypervisor. It is also possible to use multiple hypervisors each providing a set of virtual machines using at least one underlying physical machine. Different sets of virtual machines provided by one or more hypervisors may be utilized in configuring multiple instances of various components of the system.

These and other types of cloud infrastructure can be used to provide what is also referred to herein as a multi-tenant environment. One or more system components, or portions thereof, are illustratively implemented for use by tenants of such a multi-tenant environment.

As mentioned previously, cloud infrastructure as disclosed herein can include cloud-based systems. Virtual machines provided in such systems can be used to implement at least portions of a computer system in illustrative embodiments.

In some embodiments, the cloud infrastructure additionally or alternatively comprises a plurality of containers implemented using container host devices. For example, as detailed herein, a given container of cloud infrastructure illustratively comprises a Docker container or other type of Linux Container (LXC). The containers are run on virtual machines in a multi-tenant environment, although other arrangements are possible. The containers are utilized to implement a variety of different types of functionality within the information processing system 100. For example, containers can be used to implement respective processing devices providing compute and/or storage services of a cloud-based system. Again, containers may be used in combination with other virtualization infrastructure such as virtual machines implemented using a hypervisor.

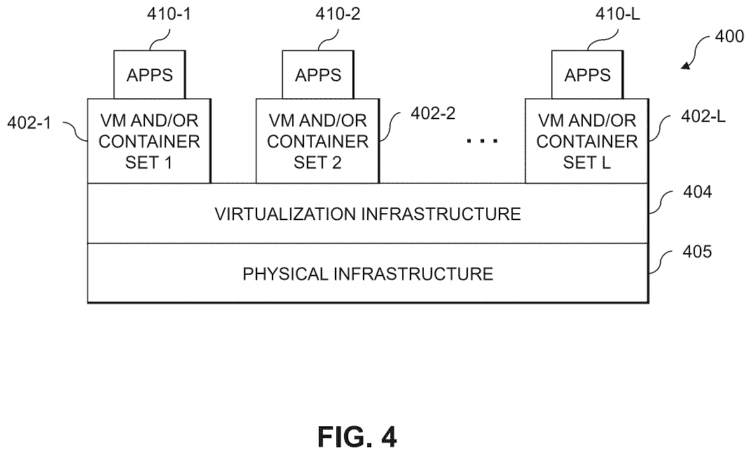

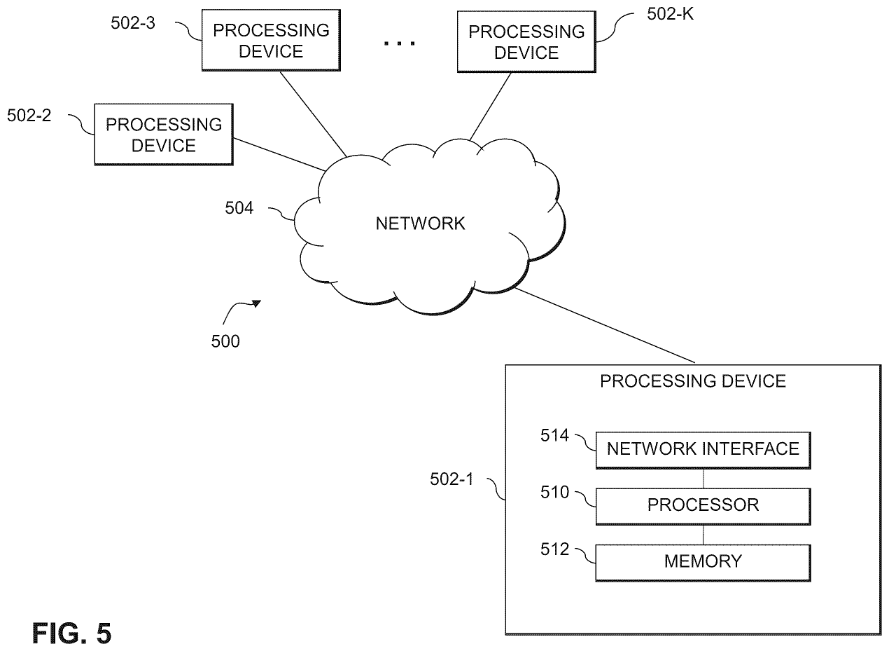

Illustrative embodiments of processing platforms will now be described in greater detail with reference to FIGS. 4 and 5. Although described in the context of the information processing system 100, these platforms may also be used to implement at least portions of other information processing systems in other embodiments.

FIG. 4 shows an example processing platform comprising cloud infrastructure 400. The cloud infrastructure 400 comprises a combination of physical and virtual processing resources that are utilized to implement at least a portion of the information processing system 100. The cloud infrastructure 400 comprises multiple virtual machines (VMs) and/or container sets 402-1, 402-2, . . . 402-L implemented using virtualization infrastructure 404. The virtualization infrastructure 404 runs on physical infrastructure 405, and illustratively comprises one or more hypervisors and/or operating system level virtualization infrastructure. The operating system level virtualization infrastructure illustratively comprises kernel control groups of a Linux operating system or other type of operating system.

The cloud infrastructure 400 further comprises sets of applications 410-1, 410-2, . . . 410-L running on respective ones of the VMs/container sets 402-1, 402-2, . . . 402-L under the control of the virtualization infrastructure 404. The VMs/container sets 402 comprise respective VMs, respective sets of one or more containers, or respective sets of one or more containers running in VMs. In some implementations of the FIG. 4 embodiment, the VMs/container sets 402 comprise respective VMs implemented using virtualization infrastructure 404 that comprises at least one hypervisor.

A hypervisor platform may be used to implement a hypervisor within the virtualization infrastructure 404, where the hypervisor platform has an associated virtual infrastructure management system. The underlying physical machines comprise one or more distributed processing platforms that include one or more storage systems.

In other implementations of the FIG. 4 embodiment, the VMs/container sets 402 comprise respective containers implemented using virtualization infrastructure 404 that provides operating system level virtualization functionality, such as support for Docker containers running on bare metal hosts, or Docker containers running on VMs. The containers are illustratively implemented using respective kernel control groups of the operating system.

As is apparent from the above, one or more of the processing modules or other components of the information processing system 100 may each run on a computer, server, storage device or other processing platform element. A given such element is viewed as an example of what is more generally referred to herein as a “processing device.” The cloud infrastructure 400 shown in FIG. 4 may represent at least a portion of one processing platform. Another example of such a processing platform is processing platform 500 shown in FIG. 5.

The processing platform 500 in this embodiment comprises a portion of the information processing system 100 and includes a plurality of processing devices, denoted 502-1, 502-2, 502-3, . . . 502-K, which communicate with one another over a network 504.

The network 504 comprises any type of network, including by way of example a global computer network such as the Internet, a WAN, a LAN, a satellite network, a telephone or cable network, a cellular network, a wireless network such as a Wi-Fi or WiMAX network, or various portions or combinations of these and other types of networks.

The processing device 502-1 in the processing platform 500 comprises a processor 510 coupled to a memory 512.

The processor 510 comprises a microprocessor, a microcontroller, an application-specific integrated circuit (ASIC), a field-programmable gate array (FPGA) or other type of processing circuitry, as well as portions or combinations of such circuitry elements.

The memory 512 comprises random access memory (RAM), read-only memory (ROM) or other types of memory, in any combination. The memory 512 and other memories disclosed herein should be viewed as illustrative examples of what are more generally referred to as “processor-readable storage media” storing executable program code of one or more software programs.

Articles of manufacture comprising such processor-readable storage media are considered illustrative embodiments. A given such article of manufacture comprises, for example, a storage array, a storage disk or an integrated circuit containing RAM, ROM or other electronic memory, or any of a wide variety of other types of computer program products. The term “article of manufacture” as used herein should be understood to exclude transitory, propagating signals. Numerous other types of computer program products comprising processor-readable storage media can be used.

Also included in the processing device 502-1 is network interface circuitry 514, which is used to interface the processing device with the network 504 and other system components, and may comprise conventional transceivers.

The other processing devices 502 of the processing platform 500 are assumed to be configured in a manner similar to that shown for processing device 502-1 in the figure.

Again, the particular processing platform 500 shown in the figure is presented by way of example only, and the information processing system 100 may include additional or alternative processing platforms, as well as numerous distinct processing platforms in any combination, with each such platform comprising one or more computers, servers, storage devices or other processing devices.

For example, other processing platforms used to implement illustrative embodiments can comprise different types of virtualization infrastructure, in place of or in addition to virtualization infrastructure comprising virtual machines. Such virtualization infrastructure illustratively includes container-based virtualization infrastructure configured to provide Docker containers or other types of LXCs.

As another example, portions of a given processing platform in some embodiments can comprise converged infrastructure.

It should therefore be understood that in other embodiments different arrangements of additional or alternative elements may be used. At least a subset of these elements may be collectively implemented on a common processing platform, or each such element may be implemented on a separate processing platform.

Also, numerous other arrangements of computers, servers, storage products or devices, or other components are possible in the information processing system 100. Such components can communicate with other elements of the information processing system 100 over any type of network or other communication media.

For example, particular types of storage products that can be used in implementing a given storage system of a distributed processing system in an illustrative embodiment include all-flash and hybrid flash storage arrays, scale-out all-flash storage arrays, scale-out NAS clusters, or other types of storage arrays. Combinations of multiple ones of these and other storage products can also be used in implementing a given storage system in an illustrative embodiment.

It should again be emphasized that the above-described embodiments are presented for purposes of illustration only. Many variations and other alternative embodiments may be used. Also, the particular configurations of system and device elements and associated processing operations illustratively shown in the drawings can be varied in other embodiments. Thus, for example, the particular types of processing devices, modules, systems and resources deployed in a given embodiment and their respective configurations may be varied. Moreover, the various assumptions made above in the course of describing the illustrative embodiments should also be viewed as exemplary rather than as requirements or limitations of the disclosure. Numerous other alternative embodiments within the scope of the appended claims will be readily apparent to those skilled in the art.

What is claimed is:

1. A method comprising:
receiving, by a pull request test recommendation system, a software pull request with changed files;
creating, by the pull request test recommendation system, a frequent pattern tree based on a minimum transaction set, wherein the minimum transaction set comprises the changed files;
applying, by the pull request test recommendation system, a frequent pattern growth algorithm to find frequent item sets based on the frequent pattern tree; and
generating, by the pull request test recommendation system, a recommended test list for the software pull request by identifying rules whose file sets are contained within the changed file set of the software pull request, wherein the method is implemented by at least one processing device comprising a processor coupled to a memory.

2. The method of claim 1 further comprising:
collecting historical pull request data including changed file sets and test sets from at least one repository to generate a hash map.

3. The method of claim 2 wherein the at least one repository comprises git history and test history.

4. The method of claim 3 wherein the test history comprises a GitHub Enterprise server.

5. The method of claim 2 wherein the hash map comprises pull request IDs as keys and corresponding sets of changed files and test names as values.

6. The method of claim 2 wherein the hash map is a hash map database that is updated periodically with additional historical pull request data.

7. The method of claim 1 wherein creating, by the pull request test recommendation system, the frequent pattern tree comprises:
checking each file in the software pull request's changed file set against transactions collected from git history; and
selecting matching transactions that contain at least one file from the changed file set to include in the minimum transaction set.

8. The method of claim 1 wherein creating, by the pull request test recommendation system, the frequent pattern tree comprises:
defining a minimum support threshold value that determines which transactions are chosen to build the frequent pattern tree.

9. The method of claim 1 wherein identifying the rules comprises:
generating rules based on the frequent item sets, wherein each rule comprises a file set and an associated test, and has a confidence value meeting or exceeding a minimum confidence threshold.

10. The method of claim 1 wherein identifying the rules comprises:
calculating support values for each frequent item set;
splitting each frequent item set into a file set and a test set; and
determining confidence values between file sets and individual tests.

11. The method of claim 10 wherein calculating support values for each frequent item set comprises:
counting occurrences of the frequent item set in all transactions.

12. The method of claim 10 wherein splitting each frequent item set into a file set and test set comprises:
generating the rules using frequent item sets comprised of one non-empty file set and one single test.

13. The method of claim 10 wherein splitting each frequent item set into the file set and the test set comprises:
filtering out any frequent item sets containing multiple tests from consideration when generating the rules.

14. The method of claim 10 wherein a confidence value represents a probability that when the file set exists in a transaction, a test also exists in the transaction.

15. The method of claim 1 wherein generating, by the pull request test recommendation system, the recommended test list comprises:
defining a minimum confidence threshold value that determines which tests are recommended.

16. The method of claim 1 wherein generating, by the pull request test recommendation system, the recommended test list comprises:
providing identified patterns with the recommended test list to clarify selection of the recommended test list.

17. The method of claim 1 wherein generating, by the pull request test recommendation system, the recommended test list comprises:
recommending tests associated with matching rules.

18. The method of claim 1 further comprising:
receiving, by a test automation system, the software pull request; and
executing, by the test automation system, the tests associated with the recommended test list.

19. A system comprising:
at least one processing device comprising a processor coupled to a memory;
the at least one processing device being configured:
to receive, by a pull request test recommendation system, a software pull request with changed files;
to create, by the pull request test recommendation system, a frequent pattern tree based on a minimum transaction set, wherein the minimum transaction set comprises the changed files;
to apply, by the pull request test recommendation system, a frequent pattern growth algorithm to find frequent item sets based on the frequent pattern tree; and
to generate, by the pull request test recommendation system, a recommended test list for the software pull request by identifying rules whose file sets are contained within the changed file set of the software pull request.

20. A computer program product comprising a non-transitory processor-readable storage medium having stored therein program code of one or more software programs, wherein the program code when executed by at least one processing device causes the at least one processing device:
to receive, by a pull request test recommendation system, a software pull request with changed files;
to create, by the pull request test recommendation system, a frequent pattern tree based on a minimum transaction set, wherein the minimum transaction set comprises the changed files;
to apply, by the pull request test recommendation system, a frequent pattern growth algorithm to find frequent item sets based on the frequent pattern tree; and
to generate, by the pull request test recommendation system, a recommended test list for the software pull request by identifying rules whose file sets are contained within the changed file set of the software pull request.
